(19) United States
(12) Patent Application Publication
(10) Pub. No.: US 2020/0355900 A1
(43) Pub. Date: Nov. 12, 2020

(54) METHOD AND APPARATUS FOR AUTOFOCUSSING AN OPTICAL MICROSCOPE AND DYNAMIC FOCUS TRACKING

(71) Applicant: WDI WISE DEVICE INC., Richmond Hill (CA)

(72) Inventors: Adam WEISS, Toronto (CA); Adrian GALEZIOWSKI, Wroclaw (PL)

(73) Assignee: WDI Wise Device Inc., Richmond Hill, ON (CA)

(21) Appl. No.: 16/760,229

(22) PCT Filed: Oct. 30, 2018
(86) PCT No.: PCT/CA2018/051372

§ 371 Date: Apr. 29, 2020

Related U.S. Application Data
(60) Provisional application No. 62/578,606, filed on Oct. 30, 2017.

(51) Int. Cl. G02B 21/24; G02B 7/38; G01B 11/14

(52) U.S. Cl. CPC G02B 21/244; G01B 11/14; G02B 7/38

(57) ABSTRACT

A method and apparatus for autofocussing an imaging device, such as an optical microscope, and dynamic focus tracking of the imaging device is disclosed herein. The apparatus includes a electrically tunable lens that is located within the apparatus such that auto-focussing can be achieved without disrupting or corrupting the image being generated or registered on the imaging device.

### CROSS-REFERENCE TO OTHER APPLICATIONS

The current application claims benefit from U.S. Provisional Application No. 62/578,606, filed Oct. 30, 2017, the contents of which are hereby incorporated by reference.

### FIELD OF THE DISCLOSURE

The disclosure is generally directed at optical microscopes and, more specifically, at a method and apparatus for autofocussing an imaging device, such as an optical microscope, and dynamic focus tracking of the imaging device.

### BACKGROUND OF THE DISCLOSURE

The use of imaging devices to obtain information about specimens has been around for a long time. In order to collect valid information, an imaging device, such as an optical microscope, must be focussed on a specimen. Typically, while the imaging device is being focussed, the microscope does not produce any usable images. As such, there is a continuous desire and effort to minimize or reduce the focussing time. Along with reducing the focussing time, there have been attempts to automate the focussing process.

For simplicity, the automatic focussing of a microscope is referred to as auto-focussing (AF) while the procedure or process to maintain the microscope in focus regardless of the specimen motion is referred to as tracking-AF.

AF methods can be divided into two general groups. A first group can be seen as an active method. Active AF methods emit energy (from a source within the imaging device) in the form of light, or laser light, to measure the distance from the objective lens of the imaging device to the specimen or sample being inspected. This distance is evaluated by analyzing the energy reflected back to the source by the specimen.

The other group of AF methods may be seen as passive methods. Passive methods are exclusively based on the processing of the information acquired by and from the imaging device (imager). This information may be an image itself or a raw video stream, which is used to calculate a Contrast Measure Function (CMF). The image is in focus when its contrast reaches a maximum value. As will be understood, contrast, also known as visibility, is commonly used for patterns where both bright and dark features are equivalent and take up similar fractions.

Current AF methods have various disadvantages. For active methods, the imaging device may lock on only reflecting (specular or diffusing) surfaces on which the specimen is located. Examples include surfaces with a mirror or semi-mirror finish or surfaces with refractive index discontinuity such as, but not limited to, between glass-air or glass-water.

In particular, active methods are not suitable for AF for specimens where a tissue sample is deposited on standard histopathology slides. In one known process, the tissue sample is adhered to a base slide and protected with a thin cover slip glass which is adhered to the base slide with a cement or adhesive having a refractive index matching the glass. The cement-tissue interface does not form a refractive index discontinuity sufficient enough for current active AF apparatus to reliably lock on. Therefore, the active method is not suitable for AF on standard histopathology slides, or standard samples protected with a cover slip in general.

Disadvantages of passive methods include, but are not limited to, unreliability in cases of low contrast samples such as, for example, hematology or fine needle biopsy specimen. Another disadvantage is that passive AF methods are slow and require a Z-scan for collecting multiple images above and below focus in order to derive the CMF (via the processing of multiple images) in order to compute the focus position. Also, passive methods are not suitable for tracking-AF because during the Z-stack acquisition (scan), the microscope is out of focus most of the time and thus scanned images would be mostly out of focus.

Therefore, there is provided a method and apparatus for autofocussing an imaging device and dynamic focus tracking that overcomes disadvantages of current systems.

### SUMMARY OF THE DISCLOSURE

The disclosure is directed at a method and system for automated control of imaging device focus. In one embodiment, the method and system of the disclosure is directed at the auto-focussing of an imaging device, such as an optical microscopes, while examining specimens, such as samples deposited on a base microscope slide and covered with a cover slip.

In another embodiment, the system and method of the disclosure is directed at applications where an imaging device is to be kept in focus even when there is a relative motion between the specimen and the objective lens of the microscope on a plane inside a specimen. Such applications may include, but are not limited to, histopathology microscopes and scanners, where the plane of interest is between base slide and cover slip; infra-red inspection of the internal layers of semiconductor chips (integrated circuits) or inspection of structures inside flat panel displays (FPD).

In another embodiment, the system and method of the disclosure may be used in the field of whole slide imaging (WSI).

In another embodiment, the system and method of the disclosure is directed at providing auto-focussing and dynamic tracking of a specimen even when the specimen is not-flat or uneven.

In one aspect of the disclosure, there is provided a hybrid auto-focussing (AF) sensor for use with an imaging device including a laser source for generating an outgoing laser beam; an apparatus for directing the outgoing laser beam towards an optical port of the imaging device; at least one electrically tunable lens (ELT) for receiving an incoming light beam; a focal array for registering an image based on the incoming light beam; and a processor; wherein the ELT is located within the hybrid AF sensor and does not disturb an optical imaging path of the imaging device.

In another aspect, the at least one ELT is turned off for an active AF mode and turned on for a passive AF mode. In a further aspect, when the system is in an active AF mode, the incoming light beam is a laser beam reflected off the specimen. In yet another aspect, the processor calculates direction and distance to focus measurements based on the laser beam reflected off the specimen. In yet a further aspect, when the system is in a passive AF mode, the incoming light beam is a light passed through the specimen. In another aspect, the light passed through the specimen is a pulsed light beam or a continuous wave light beam. In an aspect, the processor calculates a contrast measure function (CMF) based on the light passed through the specimen. In yet a further aspect, the processor controls a z-position of an objective lens of the imaging device or controls a z-position of the specimen based on the incoming light beam.

In another aspect of the disclosure, there is provided a method of auto-focussing (AF) an imaging device with an AF sensor including determining if the AF sensor should operate in an active AF mode or a passive AF mode; and turning off an electrically tunable lens (ETL) located within the AF sensor if active AF mode is required and turning on the ETL if passive mode is required.

In another aspect, if the AF sensor is operating in the active AF mode, the method includes receiving a reflected laser beam; determining direction and distance to focus measurements based on the reflected laser beam; and controlling a z-position of an objective lens of the imaging device or a z-position of a specimen based on the direction and distance to focus measurements. In a further aspect, controlling an objective lens includes transmitting a signal to the imaging device to move the objective lens. In another aspect, controlling a z-position of an objective lens includes moving the objective lens. In yet another aspect, wherein if the AF sensor is operating in the passive AF mode, the method comprising includes receiving an incoming light beam that has passed through a specimen slide; generating a z-stack of images based on the received incoming light beam; determining a contrast measure function (CMF) based on the z-stack of images; and controlling an objective lens of the imaging device based on the determined CMF. In another aspect, controlling an objective lens includes transmitting a signal to the imaging device to move the objective lens. In yet another aspect, controlling an object lens includes moving the objective lens. In an aspect, determining if the AF sensor should operate in an active AF mode or a passive AF mode includes transmitting a laser beam towards the imaging device; and detecting a level of light returned from the imaging device; wherein if a high level of light is detected, turning the ETL off and wherein if a low level of light is detected, turning the ETL on.

In a further aspect, the sensor includes a firmware for determining if the AF sensor should operate in an active AF mode of operation or a passive AF mode of operation. In an aspect, the sensor's firmware determines if there is a semi-reflective coating on a slide being illuminated by the laser source. If the coating is not detected, the laser is deactivated and sensor assumes operation in the passive mode; if the coating is detected, the laser is turned on and sensor assumes active mode of operation.

In another aspect, the sensor controls the illuminator of the imaging device. The illuminator, such as for instance white LED illuminator, is pulsed in synchrony with the imaging device and the scanner motion.

### DESCRIPTION OF THE DRAWINGS

Embodiments of the present disclosure will now be described, by way of example only, with reference to the attached Figures.

FIG. 1a is a schematic diagram of a system for active auto-focussing of an imaging device including an outgoing laser or light beam portion;

FIG. 1b is a schematic diagram of the system of FIG. 1a with an incoming or returning laser or light beam portion;

FIG. 2 is a schematic diagram of an active auto-focussing principle;

FIG. 3 is a chart outlining a relationship between optical power and driving current for a electrically tubable lens (ETL);

FIG. 4 is a schematic diagram showing a principle of applying ETL for assessing distance to focus;

FIG. 5 is a schematic graph of acquitting contrast measure function (CMF);

FIG. 6 is a schematic diagram of a calibration curve of distance to focus versus ETL driving current;

FIG. 7 is a schematic diagram of a principle of tracking video auto-focussing;

FIG. 8 is a schematic diagram of regions of interest;

FIG. 9 is a block diagram of a system for auto-focussing synchronization;

FIGS. 10a and 10b are schematic diagrams of an area scan mode configuration for a) infinity space integration and b) C or F-mount integration;

FIGS. 11a and 11b are schematic diagrams of a line scan mode configuration for a) infinity space integration and b) C or F-mount integration; and

FIG. 12 is a flowchart outlining a method of auto-focussing an imaging device.

### DETAILED DESCRIPTION OF THE PREFERRED EMBODIMENT

The disclosure is directed at a method and system for dynamically controlling auto-focussing (AF) for an imaging device. In one embodiment, the imaging device is a microscope or an optical microscope. In another embodiment, the system of the disclosure may be seen as a hybrid AF imaging device. In an embodiment, the system and method of the disclosure may include a combined laser auto-focus apparatus equipped with an electrically tunable lens for contrast AF.

Some advantages of the current disclosure include, but are not limited to, enabling contrast-based AF to operate in a tracking-AF mode; enabling an imaging device to focus on specimens lacking strong contrast features or enabling an active AF device to focus on bio-samples.

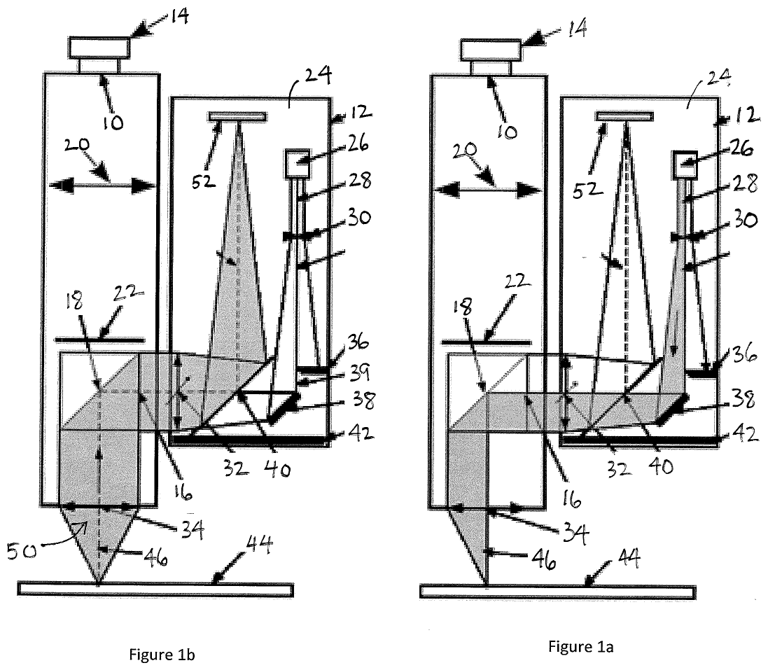

Turning to FIGS. 1a and 1b, schematic diagrams of a system for active auto-focussing of an imaging device are shown. In FIG. 1a, the figure reflects the system with an outgoing laser or light beam portion while in FIG. 1b, the figure reflects the system with an incoming or returning laser or light beam portion. The imaging device, which may be an optical microscope 10, or an infinity corrected microscope, includes an AF sensor 12. The microscope 10 further includes an imaging camera 14 that has its own undisturbed optical path between itself and a specimen 44 being inspected. This undisturbed path may be seen as a main optical path.

The AF sensor 12 is attached to an optical port 16 that is localized in an infinity range of the microscope 10. This allows a separate light path, independent from the main optical path, to be created or generated for use in auto-focussing the imaging device. Hence, a simultaneous specimen observation is facilitated by both the main imaging camera 14 and the AF sensor 12.

The AF sensor 12 further includes a housing 24 that houses a laser light source 26 that preferably emanates or delivers a collimated beam 28 (or outgoing laser beam). In a preferred embodiment, a first lens or first set of lenses 30 expand the initially small diameter laser collimated beam 28, such as to a diameter of an entry pupil of a microscope objective lens 34.

In the current embodiment, after passing the first lens 30, a portion of the laser beam is blocked by an aperture stop 36. In a preferred embodiment, half of the laser beam is blocked by the aperture stop 36. Apparatus for directing light, such as a steering mirror 38 and a beam splitter 40, directs the bisected beam 39 towards the optical port 16 of the infinity corrected microscope 10. In the current embodiment, an optically black pad 42 attenuates the residual light reflected from the beam-splitter 40. The bisected, collimated laser beam 39 reflects from the optical port beam-splitter 18 and travels to the microscope objective lens 34 and is then projected onto a specimen 44. The laser beam leaving the microscope objective lens 34 is shaped as a line as outlined by arrow 46. As can be seen, in the current embodiment, the main optical path is equipped with or includes the beam splitter 18.

Due to the presence of the separate optical paths, the distance and direction to the focus position (to auto-focus the microscope) may be measured without changing the focal length of the main optical path and/or without adjusting the microscope objective lens or specimen position. This is explained in more detail below.

Turning to FIG. 1b, a schematic diagram of the system of FIG. 1a whereby an incoming, or, returning light beam is received by the imaging device is shown.

The returning light, or laser, beam 50, after being reflected off the specimen 44, passes through the microscope objective lens 34 and is reflected by the beam splitter 18 and then directed by the AF sensor beam splitter 40 at the focal plane array 52. In a preferred embodiment, a portion (preferably about one-half) of the light collected by the microscope objective lens 34 is blocked by filter 22. In the current embodiment, returning light beam 50 is used for active auto-focussing only. The returning light beam 50 light is blocked by filter 22 so that the image focussed or generated or registered by imaging camera 14 is not corrupted by the returning light beam 50. When the system is operating in a passive AF mode, the laser light source 26 is turned off.

In one embodiment, the returning light beam 50 is reflected off the optical port beam-splitter 18 which directs the beam into the AF sensor 12. One of the AF sensor's lenses 32 (which includes an electrically tunable lens (ETL)) forms an image of the area illuminated on the specimen 44 on a focal plane array 52 with the sensor's beam-splitter 40 directs the returning light towards the focal plane array 52.

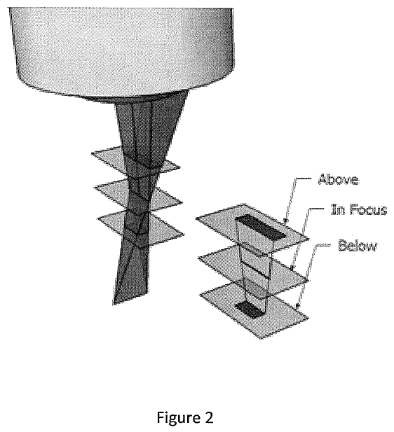

If the system is operating in an active AF mode, the AF sensor 12 uses the outgoing laser beam to project a reference line on the specimen 44. After passing through objective lens 34, the returning laser beam degenerates to a line in focus or appears as a rectangle to the left or right of the main optical axis, such as schematically shown in FIG. 2, depending on whether the specimen is below or above focus. The line width changes proportionally with respect to the distance from focus and is preferably measured by the AF sensor. The measurement may be further processed via a module, such as a software module, to derive a distance and direction to focus such as schematically shown in FIG. 2. This derivation will be understood by one skilled in the art. The measured distance to focus position is then used by the tracking-AF servo system for dynamically maintaining the microscope in focus.

As outlined above, current active AF methods suffer problems when used with histopathology slides as current active AF sensors either focus on the top of the cover slip or the bottom of the base slide due to the strong refractive index discontinuity at the glass-air interface. In order to overcome this problem, in the present disclosure, a semi-reflective coating is applied to a top layer of the base slide 44. The reflectance of this layer is preferably at a level between about 15% to about 50% to dominate over the reflection from the glass-air interfaces, which are at the level of about 4%. In the preferred embodiment, the semi-reflective coating is deposited using a magnetron. In one embodiment the coating includes a layer of titanium nitrate and a layer of titanium oxide.

With respect to image-based auto-focus systems, the system of the disclosure is preferably able to operate in dual operation modes. Beside the described above active AF (laser AF) mode, the system of the disclosure may also operate in an image based passive AF mode. As will be understood, a drawback of any image based auto-focus system is its speed of operation. The time which is required to collect a sufficient number of images is unacceptable for tracking auto-focus purposes. In the system of the disclosure, the system includes an electrically tunable lens (ETL) for collecting the z-stack of images necessary for finding best focus based on image contrast.

The present disclosure overcomes at least some of the problems of current system while maintaining that the main optical path remains undisturbed.

In one embodiment of the disclosure, the ETL is integrated with the laser auto-focus outside of the main optical path of the imaging device. As the contrast based (passive AF) system and the laser (active AF) system share common elements, the system of the disclosure is compact and takes full advantage of the benefits of active AF as well as passive AF in a single hybrid AF system.

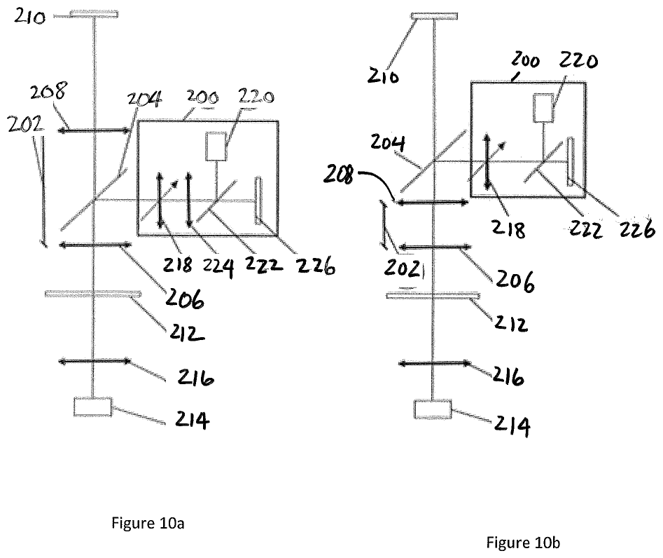

Turning to FIG. 10a, a schematic diagram of the AF sensor being used in a passive AF mode is shown. In order to facilitate understanding, the components of the AF sensor that are only used in the active AF mode are shown as laser optics 220. In the passive AF mode, these components are inactive.

When in the passive mode, the incoming light beam is generated by an illuminator 214 associated with the imaging device. In a preferred embodiment, the illuminator 214 is a white light emitting diode (LED). The light beam generated by the illuminator 214 passes through a condenser 216 and illuminates the specimen 212. The light that passes through the specimen reaches the objective lens 206 (which may also be seen as objective lens 34 from FIG. 1) of the imaging device where it is then split by the beam splitter 204 (which may be seen as beam splitter 18). In a preferred embodiment, the light beam is split in half with one half passing through the imaging device's tube lens (TL) to generate a specimen image on the imager 210 (which may be seen as imaging camera 14). The other half of the light beam is directed by the beam splitter 204 towards the AF sensor 200 (or 12) which then reaches a compound lens including the ETL 218 (and the AF sensor's TL 224). In this manner, the image being generated on the imager 210 is undisturbed by the auto-focussing.

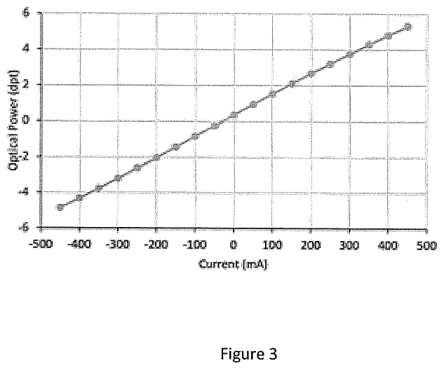

As the ETL varies its optical power proportionally to the applied current, in the preferred embodiment, the focal length of the TTL can be varied from negative through infinity (no optical power) to a positive value. FIG. 3 illustrates this relationship. As temperature may also affect the focal length of the ETL, in one embodiment, to compensate for this parasitic effect, the temperature of the ETL is continually monitored and corrected according to calibration data.

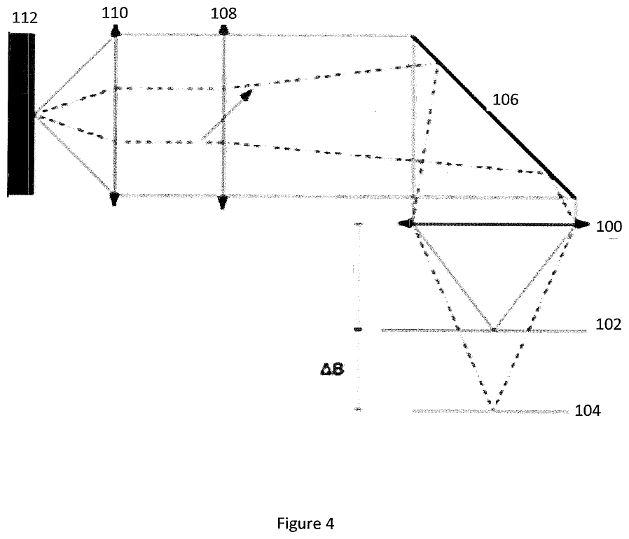

An optical diagram of the AF sensor operating as a contrast based (passive mode) AF sensor is shown in FIG. 4. In this figure, the components for the active mode AF have been left out for clarity. In this figure, light collected by the microscope objective lens 100 from the object (or specimen) plane 102 or 104 is reflected by the beam splitter 106 and after passing through an ETL 108 and sensor's tube lens 110 reaches the imager 112 (or the focal array plane). In the preferred embodiment, the beam splitter 106 is preferably about 50% reflective and about 50% transmissive although other percentages are contemplated. As the AF is progressing, the light transmitted through the beam splitter 106 also passes through the microscope tube lens (not shown) and forms a specimen image on the main imager (not shown). In this manner, the specimen image that is formed on the main imager is not disturbed or disrupted by varying the focal length of the compound sensor's TL 108 and 110.

When the microscope is in focus i.e. points to the object plane 102 and the ETL optical power is set to zero (infinity focal length (FL)), both the image seen by the AF sensor 12 and the main optical path imager registers the sharpest image.

The objective lens 100 together with the ETL 108 may also be seen as a compound lens (as outlined above). The focal length of this compound lens can be approximated by the thin lens formula:

1/f_{C}=1/f_{O}+1/f_{E}, Equation 1
where f_{C} compound lens FL
   f_{O} objective lens FL
   f_{E} ETL FL

Therefore:

f_{C}=(f_{O}*f_{E})/(f_{O}+f_{E}) Equation 2

It can be seen from Equation 2 that if the ETL's focal length is infinite (zero optical power), the compound lens FL equals the objective FL.

By driving electrical current through the ETL 108, the finite focal length may be set resulting in a change in the compound lens FL and consequently the sensor's focal plane array. This is schematically shown in FIG. 4 with the dashed line. When the ETL's FL is set to a negative value, this results in a shift of sensor's focal plane position from 102 to 104 by a distance of ΔB. The microscope's main focal plane remains unchanged since the microscope's imaging path does not include the ETL.

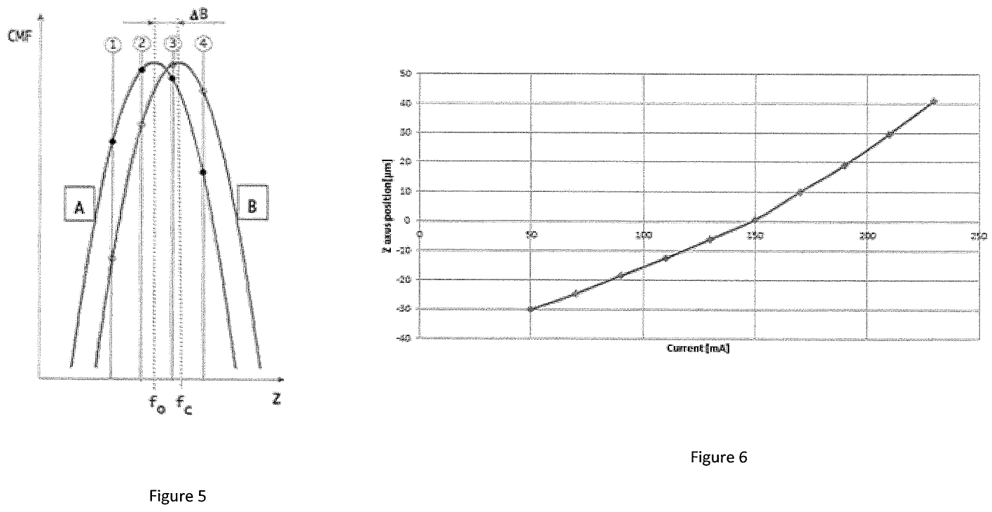

Following this principle of operation, by modulating the current through the ETL, the z-stack of images can be acquired and the contrast measure computed for each image. The results of such computation are schematically presented in FIG. 5. Points from 1 to 4 on curves A and B represent discrete contrast measures computed from 4 images per curve. The line interpolating between contrast measure points (depicted as dots and circles respectively) represents the Contrast Measure Function (CMF) and the maximum on this curve represents the in-focus position.

It can be seen, that the stack of multiple focal planes can be acquired without changing a physical position of the microscope objective lens or the specimen. Each collected image is further processed, by an image processor, which associates a contrast measure value to each frame.

If the maximum, or a high level measurement of, CMF (curve A) coincides with the front focal plane of the objective lens f_{O}, the microscope is deemed to be in focus. If the maximum, or a high level measurement of, the CMF deviates from f_{O} position, and is found in the f_{C} point corresponding to the focal plane of the compound lens—objective and ETL—the distance to focus ΔB can be computed as follows:

ΔB=f_{C}−f_{O} Equation 3

Shifting the objective lens (or specimen) by ΔB brings the microscope to focus.

In a practical implementation, the relation between the ETL driving current and the distance to the best focus ΔB for each objective lens in use may be established by a calibration process. An example calibration curve for a 20− objective lens is shown in FIG. 6.

In case of tracking video AF, there are additional complications that need to be addressed. Firstly, the CMF should be computed using the same scene within the image z-stack even though each image within the z-stack is different from one another due to the scanning process. This requirement may be referred to as spatial invariance. Another complication is that the z-stack collection must be fast enough but not disturb the rhythm of acquiring images along the main optical path i.e. the imager frame rate of the AF sensor 12 is preferably at least 4 times faster than the frame rate of the main optical path. This may be referred to as sensor imager frame rate.

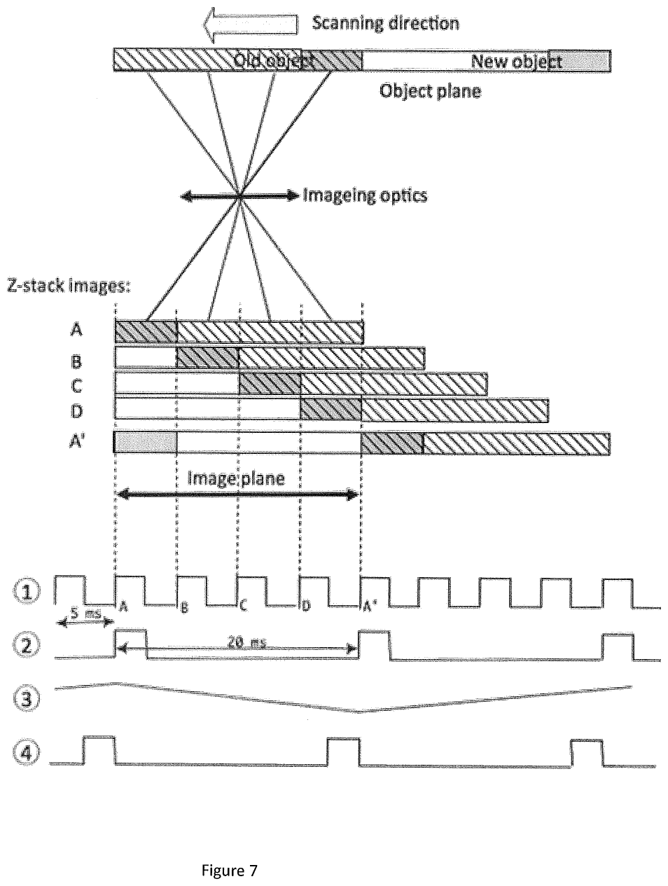

In a preferred embodiment, the spatial invariance is addressed such that, in each image of the z-stack, there is the common part (the shaded portions in FIG. 7) progressing within the z-stack images from position A to D (the 4 images deep z-stack is used in the preferred embodiment of the disclosure).

As the scanned object progresses in the scanning direction, the image segment—marked as dashed grayed region—progresses from image to image from left to right (the object moves from right to left) and its content does not change in the images from A to D, so the CMF can be calculated obeying the spatial invariance requirement. Once the CMF is calculated, the position of the objective lens is adjusted for the best focus. The fifth image (D) captured by both the main imaging camera and the AF focal array plane and the subsequent AF iteration is then started.

The timing diagram of this process is shown in the bottom part of FIG. 7. ETL is controlled with the current linearly ramping up and down in timing diagram 3. While the ETL is varying its optical power (timing diagram 3), sensor's imager captures images of consecutive focal planes (timing diagram 1) on the rising edge—from A to D—of the synchronization waveform (timing diagram 1). After z-stack is captured, the ΔB is computed and the objective lens position corrected (timing diagram 4) according to the calibration curve just prior to the image capture by the main camera (timing diagram 2). At this instance (A′), the all-new image is rolled into the camera view and the new AF iteration begins.

The same timing diagram and z-stack acquisition principles applies to the case of line scan type of main imager. In this case, however the scanned image builds as the continuous ribbon and timing point corresponding to the image frame has only a conventional rather than physical meaning, but still is required for synchronizing the line scan main imager with the area scan sensor imager.

In the line scan mode, the illumination is preferably a continuous wave (CW) and not pulsed as required in area scan mode and by the sensor imager. The method of separating these two modes of illumination is discussed below.

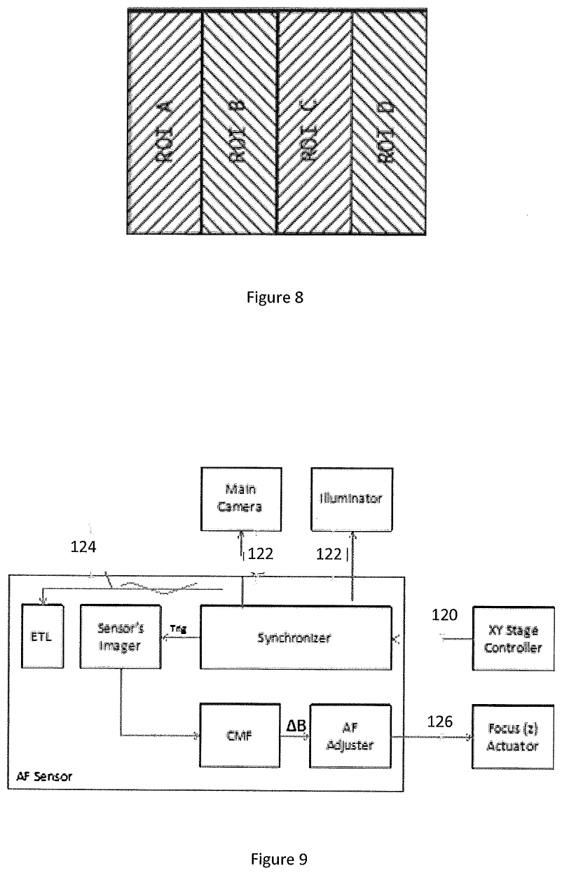

With respect to sensor imager frame rate, in order to enable the AF sensor imager frame rate to be at least 4 times faster than the frame rate of the imaging device, in the preferred embodiment of the disclosure, the imager area is divided into four Regions of Interest (ROls) as per FIG. 8. Each ROI corresponds to ¼ of the overall imager size and captures the spatially invariant part of image to eventually form the A to D z-stack of images. Since for each of these z-stack positions only ¼ of the imager is read, the frame rate in this imaging mode is four times faster than for the main imager where the entire image is read.

Turning to FIG. 9, a schematic diagram of another embodiment of a system for auto-focussing is shown. FIG. 9 illustrates one implementation of the principles presented in FIG. 7.

In operation, the XY stage controller sends a pulse illumination every time ¼ of the FOV is ready for acquiring. These pulses are sent on the fixed spatial intervals basis. Based on this signal, the sensor's imager is triggered. The synchronizer (implemented in the sensor's FPGA) derives from the signal 120, a main camera trigger signal 122, which in this particular implementation is sent every 5-th pulse of signal 120. The synchronizer also controls and synchronizes the generation of the triangular waveform 124, which controls ETL. Once the image stack of images A to D is collected, the ΔB is computed and the signal 126 is sent to focus actuator for correcting the objective lens position to the best focus spot.

The system of the disclosure, preferably incorporates in one housing, the components to perform two complementary auto-focussing methods, thereby to providing a hybrid auto-focus mechanism. As both methods share common elements i.e. optics, imaging device (imager) and processing unit, the sensor is capable of autonomously switching between laser (active AF mode) auto-focus and contrast (passive AF mode) detection.

When the returning laser beam 50 is strong and/or flawless, such as when coated slides are used, this condition is sensed or detected by the AF sensor and the AF sensor 12 operates in the active mode to determine focus position. On the contrary, when the laser signal is weak or uncertain, the sensor may switch to passive mode or may operate in its default contrast based mode. In another embodiment, a mixed mode of operation is also contemplated where both methods can be combined, such as in the case of a very difficult specimen. For example, in the case of a bio-sample with a low contrast value, an active AF, or laser, method can be used to obtain a cover glass position as a reference point and then a jump towards focus can be performed in increments corresponding to the known cover glass thickness. This will bring the microscope very close to focus and facilitate the AF task by reducing it to focus refinement. Dual operation mode assures that sensor is constantly near focus position, regardless of the sample properties and is capable of fulfilling a tracking auto-focus application.

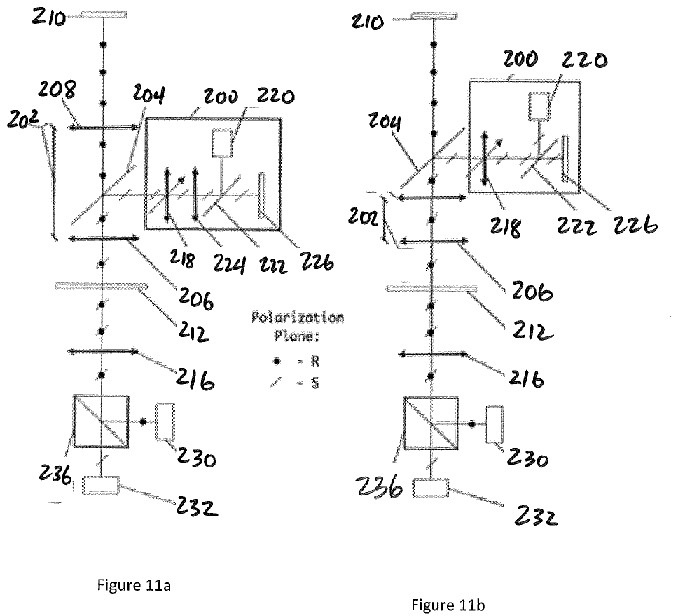

Other configurations of a hybrid AF sensor are also contemplated. Firstly, as shown in FIGS. 10a and 10b, an area scan configuration is shown while in FIGS. 11a and 11b, a line scan configuration is shown.

FIGS. 10a and 10b schematically illustrate an area scan operation configuration. In this figure two options of integrating AF are presented. FIG. 10a shows the AF sensor coupled into an infinity space of a microscope and FIG. 10b shows the AF sensor coupled to a non-infinity space, normally occupied by the imaging camera mount (typically C-mount or F-mount).

As discussed above with respect to FIG. 10a, the AF sensor 200 is coupled to the infinity range 202 of the microscope by the beam-splitter 204. The beam splitter 204 directs a portion of the light (usually one-half) collected by the objective lens 206 towards AF sensor 200. The remaining portion of this light passes through a tunable lens 208 (associated with the imaging device) to form an image on a main area scan imager 210. This is undisturbed by the returning or reflected light. In the current embodiment, specimen 212 is illuminated by pulsed LED illuminator 214 through the condenser lens system 216. In a preferred embodiment, the pulsed illuminator 214 is in sync with AF sensor 200 and the area scan camera 210. A pulsed light source enables ‘freezing’ a specimen motion, while the AF sensor is performing a contrast based tracking AF operation. In this mode, ETL 218 varies its focal length, thus changing a compound lens focal length (as outlined in Equation 2). Sensor analyses multiple focal planes without affecting the objective lens position. Once, the best focus location is determined, the microscope objective lens position is updated.

For the laser, or active, AF mode, the ETL's focal length is set to infinity. Laser beam originating from the laser optics 220 reflects from the sensor beam splitter 222, passes through the sensor projection lens (sensor's TL) 224 and is reflected by the beam splitter 204 to finally—after passing through the objective 206—form the structured light image on the specimen 212. Then the laser light reflected back by the specimen 212 passes through objective lens 206 and is directed by beam-splitter 204 towards sensor 200 for forming an image of the structured light pattern on the sensor's imager 226. By analysing this image, the distance and direction to auto-focus the microscope is determined by the sensor's firmware and the objective lens position is updated.

FIG. 10B is directed at a variation of the configuration of FIG. 10A. In FIG. 10B, the AF sensor 200 is coupled with the beam splitter 204 between the microscope tunable lens 208 and the main area scan imager 210 and thus the sensor's tunable lens is not needed and is removed from the optical path. The microscope tunable lens 208 is shared by the microscope and the AF sensor i.e. it forms the image on the main area scan imager 210 and the sensor's imager 226.

The principle of operation of contrast (passive) and laser (active) AF remains the same in both of these configurations and selection of one of these is dependent on system integrator preference/discretion.

Turning to FIGS. 11a and 11b, configurations where the main imaging device is a line scan type imager are shown. The reference numbers in FIGS. 11a and 11b are the same as those used in FIGS. 10a and 10b. The difference between these configurations and configurations of FIGS. 10a and 10b are that the line scan camera uses CW illumination (i.e. not pulsed) and the sensor's imager requires pulsed illumination. In order to accomplish this, two illuminators are provided 230 and 232. In the current embodiment illuminator 232 provides pulsed illumination with its light is polarized in polarization plane S. This illumination is provided to be used by the AF sensor 200. The second illuminator provides light polarized along plane P, is of the CW type and is used by the main, line scan imager.

Similarly, to the area scan camera configurations (FIGS. 10a and 10b), two variations of optical configurations are possible. FIG. 11a is directed at an AF sensor coupled to the microscope infinity range and FIG. 11b is directed at an AF sensor coupled to the microscope in the space between the camera and microscope's tube lens. The principle of operation of contrast and laser AF remains the same in both of these configurations and selection of one of these is dependent on system integrator preference/discretion.

Turning to FIG. 11a, the light from illuminators 230 & 232 are combined by a polarizing beam splitter (PBS) 234 and after passing through the condenser lens system 216 illuminates the specimen 212. Light effected by the specimen 212 is collected by the microscope objective lens 206 and directed towards a second PBS 236. The second PBS 236 splits the polarization planes and the pulsed light of the polarization S is directed towards the AF sensor 200 and the CW illumination of the polarization P continues via TL 208 towards the main line scan imager 210.

Due to the orthogonal polarizations, the AF sensor 200 does not see the CW illumination and the line scan imager does not see the pulsed illumination. As will be understood, the configuration of P and S polarization planes is arbitrary and can be reversed according to the system integration convenience.

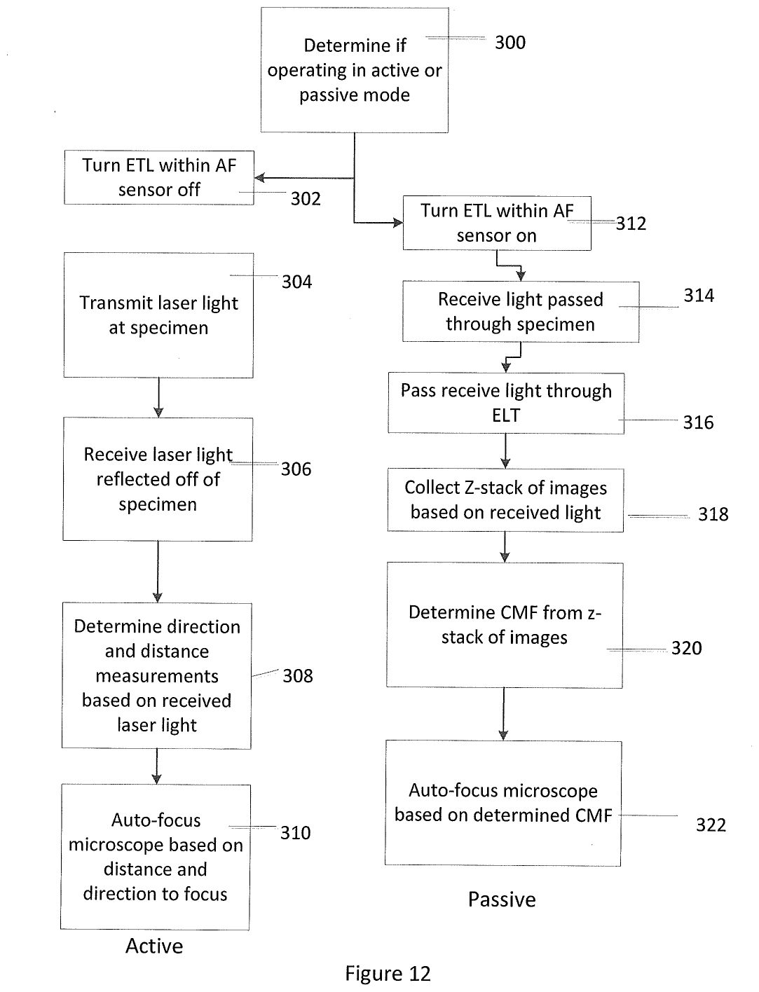

Turning to FIG. 12, a flowchart outlining a method of auto-focussing is shown. Initially, the AF sensor determines if the imaging device should be focussed using an active AF mode or a passive AF mode (300). In one embodiment, this may be achieved by directing a laser beam from within the AF sensor towards the specimen and then detecting the amount of light that is returned. If the level of light detected is above a predetermined threshold, the system is set to operate in an active AF mode and if the level of light detected is below a predetermined threshold, the system is set to operate in a passive AF mode. In order to assist the system in determining the mode to use, the specimen being inspected may include a semi-reflective coating. In this embodiment, if the semi-reflective coating is sensed or detected, the system is set to operate in the active AF mode and, if not detected, the system is set of operate in the passive AF mode.

If the system operates in an active AF mode, the ETL within the AF sensor is turned off (302). A laser light beam is then generated and transmitted towards the specimen (304) such as via the laser light source 26 and the apparatus or components for directing the laser light beam at the specimen. An incoming laser light beam is then received (306) such as one that is reflected off the specimen. The incoming laser light beam passes through the ETL (which is turned off such that it does not affect the incoming laser light beam). Based on this incoming laser light beam, direction and distance to focus measurements are calculated (308). The imaging device is then focussed based on the direction and distance to focus measurements (310) such as by moving or controlling the objective lens of the imaging device or moving or controlling the position of the specimen.

If the system operates in a passive AF mode, the ETL within the AF sensor is turned on (312). The light that is transmitted through or passed through the specimen, such as by an illuminator, is then received (314). In one embodiment, the AF sensor controls the illuminator to synchronize it with the XY stage motion. The incoming light beam then passes through the ETL (316). A z-stack of images based on the receiving or incoming light beam are then generated or collected (318). Based on the z-stack of images, a CMF can be determined (320). Using this CMF, the objective lens of the imaging device can be controlled or moved in order to focus the imaging device (322). Alternatively, the z-position of the specimen may be moved to adjust the focus with the objective lens staying stationary.

In one embodiment, the disclosure is directed at a hybrid auto-focus sensor that provides a tracking functionality for passive and active AF methods. Even though the disclosure may be directed for whole slide imaging, it is applicable to other uses requiring scanning with a microscope.

For AF on low contrast slides, active or laser AF is used. In one embodiment, to assist in enabling focussing on the tissue layer using laser AF, the use of slides coated with the semi reflective layer is preferred. This semi-reflective layer causes the laser light to reflect back to the AF sensor from the desired plane. For AF on regular, high contrast slides, the contrast based AF system includes an electrically tunable lens (ETL) which varies its optical power proportionally to the control current. In one aspect of the disclosure, the laser AF sensor and contrast based AF sensor are integrated in the same housing as there are common components for performing both methods.

In a preferred embodiment, the hybrid auto-focus sensor automatically recognizes the optical properties of the specimen and selects an active AF mode of operation. For instance, if the sensor detects the semi-reflective coating on the slide. Alternatively, the AF sensor may select a passive, contrast based AF mode of operation if the semi-reflective coating is not detected.

The hybrid auto-focus sensor is preferably integrated with the microscope via a dedicated optical port equipped with the beam-splitter. This establishes a separate optical path for AF purposes and does not affect the imaging path of the microscope. Splitting the imaging path from the AF path allows for undisturbed specimen observation, while focus position is sampled. Similarly, as in active AF methods, the objective position is corrected for the best focus as soon as the new best focus position is computed. It is assured by design, that the objective position corrections are frequent enough, that the microscope always remains within its depth of field guaranteeing that all the acquired images appear to be firmly in focus.

The disclosure is also directed at a method of operation for area scan as well as line scan devices is described. A pulsed light source, or illuminator, synchronized with the imaging device and AF sensor “freezes” sample motion, enabling tracking of the auto-focussing process. In case of line scan application, a pulsed illuminator is combined with continuous wave (CW) illuminator. Both illuminators are preferably separated by having orthogonal light polarizations.

Although the present disclosure has been illustrated and described herein with reference to preferred embodiments and specific examples thereof, it will be readily apparent to those of ordinary skill in the art that other embodiments and examples may perform similar functions and/or achieve like results. All such equivalent embodiments and examples are within the spirit and scope of the present disclosure.

In the preceding description, for purposes of explanation, numerous details are set forth in order to provide a thorough understanding of the embodiments. However, it will be apparent to one skilled in the art that these specific details may not be required. In other instances, well-known structures may be shown in block diagram form in order not to obscure the understanding. For example, specific details are not provided as to whether elements of the embodiments described herein are implemented as a software routine, hardware circuit, firmware, or a combination thereof.

Embodiments of the disclosure or components thereof can be provided as or represented as a computer program product stored in a machine-readable medium (also referred to as a computer-readable medium, a processor-readable medium, or a computer usable medium having a computer-readable program code embodied therein). The machine-readable medium can be any suitable tangible, non-transitory medium, including magnetic, optical, or electrical storage medium including a diskette, compact disk read only memory (CD-ROM), memory device (volatile or non-volatile), or similar storage mechanism. The machine-readable medium can contain various sets of instructions, code sequences, configuration information, or other data, which, when executed, cause a processor or controller to perform steps in a method according to an embodiment of the disclosure. Those of ordinary skill in the art will appreciate that other instructions and operations necessary to implement the described implementations can also be stored on the machine-readable medium. The instructions stored on the machine-readable medium can be executed by a processor, controller or other suitable processing device, and can interface with circuitry to perform the described tasks.

What is claimed is:

1. A hybrid auto-focussing (AF) sensor for use with an imaging device comprising:
a laser source for generating an outgoing laser beam;
an apparatus for directing the outgoing laser beam towards an optical port of the imaging device;
at least one electrically tunable lens (ELT) for receiving an incoming light beam;
a focal plane array for registering an image based on the incoming light beam; and
a processor;
wherein the ELT is located within the hybrid AF sensor and does not disturb an optical imaging path of the imaging device.

2. The hybrid AF sensor of claim 1 wherein the at least one ELT is turned off for an active AF mode and turned on for a passive AF mode.

3. The hybrid AF sensor of claim 2 wherein in an active AF mode, the incoming light beam is a laser beam reflected off the specimen.

4. The hybrid AF sensor of claim 3 wherein the processor calculates direction and distance to focus measurements based on the laser beam reflected off the specimen.

5. The hybrid AF sensor of claim 2 wherein in a passive AF mode, the incoming light beam is a light passed through the specimen.

6. The hybrid AF sensor of claim 5 wherein the light passed through the specimen is a pulsed light beam or a continuous wave light beam.

7. The hybrid AF sensor of claim 6 wherein the processor calculates a contrast measure function (CMF) based on the light passed through the specimen.

8. The hybrid AF sensor of claim 1 wherein the processor controls a z-position of an objective lens of the imaging device or controls a z-position of the specimen based on the incoming light beam.

9. A method of auto-focussing (AF) an imaging device with an AF sensor comprising:
determining if the AF sensor should operate in an active AF mode or a passive AF mode; and
turning off an electrically tunable lens (ETL) located within the AF sensor if active AF mode is required and turning on the ETL if passive mode is required.

10. The method of claim 9 wherein if the AF sensor is operating in the active AF mode, the method comprising:
receiving a reflected laser beam;
determining direction and distance to focus measurements based on the reflected laser beam; and
controlling a z-position of an objective lens of the imaging device or a z-position of a specimen based on the direction and distance to focus measurements.

11. The method of claim 10 wherein controlling an objective lens comprises:
transmitting a signal to the imaging device to move the objective lens.

12. The method of claim 10 wherein controlling a z-position of an object lens comprises:
moving the objective lens.

13. The method of claim 10 wherein if the AF sensor is operating in the passive AF mode, the method comprising:
receiving an incoming light beam that has passed through a specimen slide;
generating a z-stack of images based on the received incoming light beam;
determining a contrast measure function (CMF) based on the z-stack of images; and
controlling an objective lens of the imaging device based on the determined CMF.

14. The method of claim 13 wherein controlling an objective lens comprises:
transmitting a signal to the imaging device to move the objective lens.

15. The method of claim 13 wherein controlling an object lens comprises:
moving the objective lens.

16. The method of claim 10 wherein determining if the AF sensor should operate in an active AF mode or a passive AF mode comprises:
transmitting a laser beam towards the imaging device; and
detecting a level of light returned from the imaging device;
wherein if a high level of light is detected, turning the ETL off and wherein if a low level of light is detected, turning the ETL on.
